(19) United States
(12) Patent Application Publication
(10) Pub. No.: US 2011/0134349 A1
(43) Pub. Date: Jun. 9, 2011

(54) Multi-stable Liquid Crystal Display Device and Driving Method Thereof

(76) Inventors: Jhih-Sian Wu, Taichung City (TW); Hui-Yu Chen, Yilan County (TW); Szu-Fen Chen, Taoyuan County (TW)

(21) Appl. No.: 12/758,029

(22) Filed: Apr. 11, 2010

(30) Foreign Application Priority Data
Dec. 3, 2009 (TW) 098141342

(51) Int. Cl. G02F 1/133; G02F 1/1343

(52) U.S. Cl. 349/34; 349/141

(57) ABSTRACT

A multi-stable liquid crystal display device is provided. The device includes a first substrate, a second substrate, a first electrode, a second electrode and a liquid crystal layer. The first substrate and the second substrate are disposed opposite to each other. The first electrode is disposed on the first substrate. The second electrode is disposed on the side of the second substrate facing the first substrate. At least one of the first electrode and the second electrode includes a grating electrode. The liquid crystal layer includes smectic liquid crystal molecules. Moreover, a method of driving the multi-stable liquid crystal display device is further provided in the present invention.

### BACKGROUND OF THE INVENTION

1. Field of the Invention

The present invention relates to a multi-stable liquid crystal display device, and more particularly, to a multi-stable liquid crystal display device with a special electrode arrangement.

2. Description of the Prior Art

In the past twenty years, because of the advantages of lightness, slimness, shortness and small size, the liquid crystal display (LCD) devices such as twisted nematic (TN) LCD devices and super twisted nematic (STN) LCD devices have gradually become the mainstream products of the display devices.

However, all of the abovementioned LCD devices can only provide single-stable display mode. That is, the liquid crystal molecules have only one stable state. The display device needs a driving voltage to twist the liquid crystal molecules. If the voltage is removed, the liquid crystal molecules return to their single-stable state. Therefore, the single-stable LCD devices should be continuously supplying a voltage to maintain the images, causing a high-power-consumption problem. In the recent years, a bi-stable LCD device is developed. The liquid crystal molecules in the bi-stable LCD device have two stable states, a twisted state and an un-twisted state, thereby providing a bi-stable state display mode. In other words, the LCD device can maintain the displayed images even when no voltage is supplied, being advantageous in power consumption. This technology can be used in mobile phones, e-books or other monitors that do not need frequent updates.

In the current bi-stable display technologies, the liquid crystal molecules usually include nematic liquid crystal molecules, cholesteric liquid crystal molecules or smectic liquid crystal molecules. The cholesteric liquid crystal molecules have helical structures. When supplying an electric field, the axial direction of the liquid crystal molecules is changed and the liquid crystal molecules can be switched between a light state and a dark state. The nematic liquid crystal molecule itself is a single-stable state material. Other compounds are needed to mix with the nematic liquid crystal molecules to form a special structure to achieve the purpose of bi-stable state display. However, it is also unable to expand up to a multi-state display mode. In the recent years, some studies of utilizing nematic liquid crystal molecules to achieve a bi-stable state mode are provided. However, the driving methods are still clinging to old ideas where the only change is to improve the structure of the chemical molecules, or to improve the electro-optical nature by adding some ion impurities, both of which are unable to address the contrast issue and can not lead to a multi-stable display mode. Therefore, an LCD device for smectic liquid crystal molecules that has multi-stable display mode is still needed.

### SUMMARY OF THE INVENTION

The present invention therefore provides a multi-stable LCD device that is suitable for smectic liquid crystal molecules. The multi-stable LCD device with special electrode arrangement can improve display contrast and can provide multi-stable display mode.

The multi-stable liquid crystal display device in the present invention includes a first substrate, a second substrate, a first electrode, a second electrode and a liquid crystal layer. The first substrate and the second substrate are disposed opposite to each other. The first electrode is disposed on the first substrate. The second electrode is disposed on the side of the second substrate facing the first substrate. At least one of the first electrode and the second electrode includes a grating electrode. The liquid crystal layer includes smectic liquid crystal molecules.

The method of driving a multi-stable liquid crystal display device in the present invention is provided. First, a multi-stable LCD device is provided. The multi-stable LCD device includes a first substrate, a second substrate, a first electrode, a second electrode and a liquid crystal layer. The first substrate and the second substrate are disposed opposite to each other. The first electrode is disposed on the first substrate. The second electrode is disposed on the side of the second substrate facing the first substrate. At least one of the first electrode and the second electrode includes a grating electrode. The liquid crystal layer includes smectic liquid crystal molecules. Next, a planar electric field is provided to increase the light transmittance of the liquid crystal layer. And, a vertical electric field is provided to decrease the light transmittance of the liquid crystal layer.

The multi-stable LCD device in the present invention uses smectic liquid crystal molecules and uses special electrode structure to drive the smectic liquid crystal molecules. The multi-stable LCD device includes a “bi-layer electrode” structure or a “tri-layer electrode” structure. The multi-stable LCD device in the present invention can not only provide multi-stable display mode but also has advantages of high-contrast and low-power-consumption and is applicable to reflective type LCD devices or transmissive type LCD devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 3 illustrate schematic diagrams of the first embodiment of the multi-stable LCD device in the present invention.

FIG. 4 and FIG. 5 illustrate top view schematic diagrams of the patterns of the grating electrode.

FIG. 6 illustrates a schematic diagram of the dark/light state switch of the multi-state LCD device in the present invention.

FIG. 7 illustrates a schematic diagram of the multi-stable display switch of the multi-stable LCD device in the present invention.

FIG. 8 and FIG. 9, illustrate schematic diagrams of the second embodiment of the multi-stable LCD device in the present invention.

FIG. 10 illustrates a schematic diagram of the contrast value of the second embodiment of the multi-stable LCD device in the present invention.

FIG. 11 illustrates a schematic diagram of the third embodiment of the multi-stable LCD device in the present invention.

FIG. 12 illustrates a schematic diagram of a comparison of the voltages between the hybrid orientation and the vertical orientation in the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

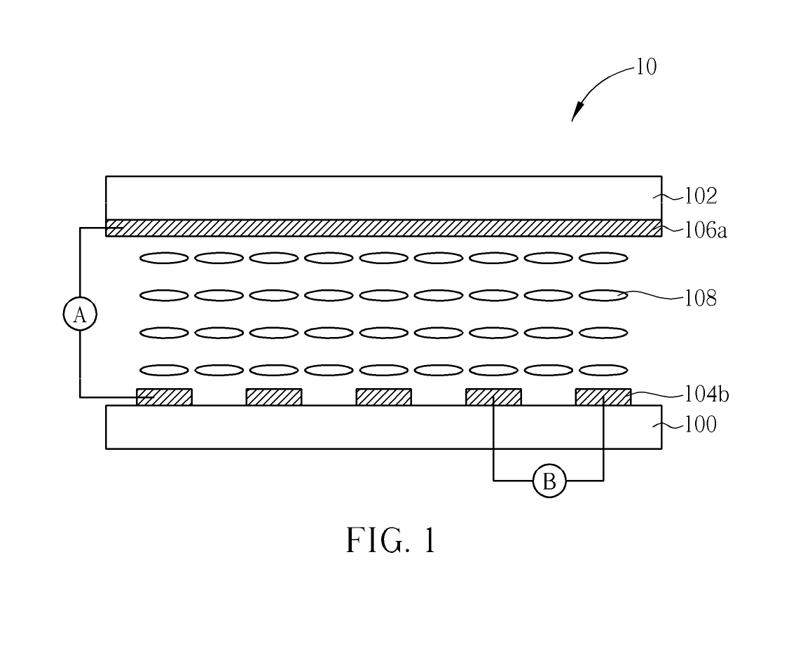

Please refer to FIG. 1 to FIG. 3, illustrating schematic diagrams of the first embodiment of the multi-stable LCD device in the present invention. As shown in FIG. 1, the multi-stable LCD device 10 in the present embodiment includes a first substrate 100, a second substrate 102, a first electrode 104, a second electrode 106 and a liquid crystal layer 108. The first substrate 100 and the second substrate 102 are disposed opposite to each other. The first electrode 104 and the second electrode 106 are disposed on the inner sides of the two substrates 100, 102. That is, the first electrode 104 is disposed on the side of the first substrate 100 facing the second substrate 100, and the second electrode 106 is disposed on the side of the second substrate 102 facing the first substrate 100. The liquid crystal layer 108 is disposed between the first electrode 104 and the second electrode 106.

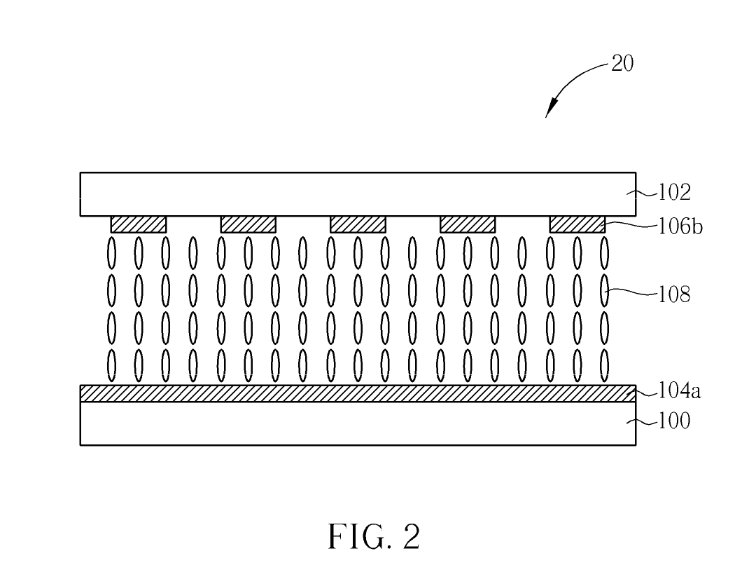

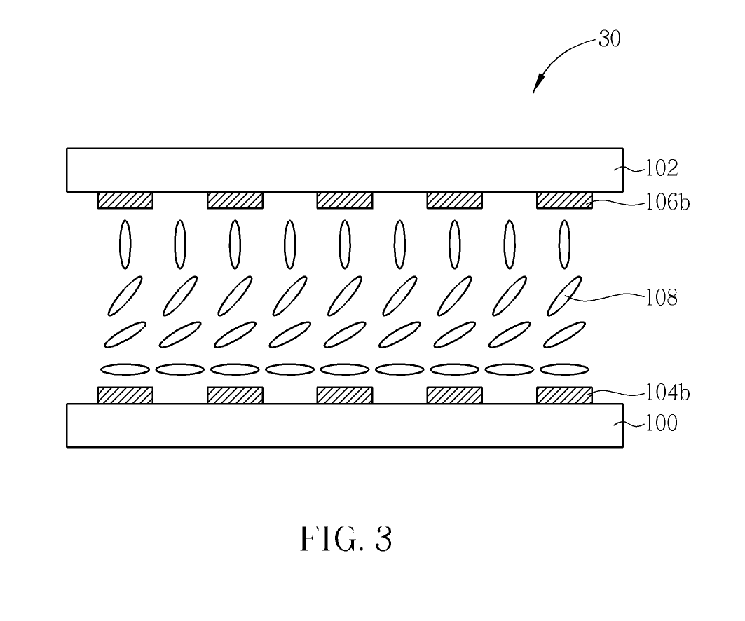

It is one salient feature in the present invention that at least one of the first electrode 104 and the second electrode 106 includes a grating electrode structure. As shown in FIG. 1 of the present embodiment, the first electrode 104b is a grating electrode and the second electrode 106a is a planar electrode which comprehensively covers the second substrate 102. In order to clarify the distinctions, “a” represents the planar electrode while the “b” represents the grating electrode, wherein similar naming will be designated in the following embodiments. In another embodiment, as shown in FIG. 2, the first electrode 104a is a planar electrode and the second electrode 104b is a grating electrode. Or, as shown in FIG. 3, the first electrode 104b and second electrode 106b are both grating electrodes.

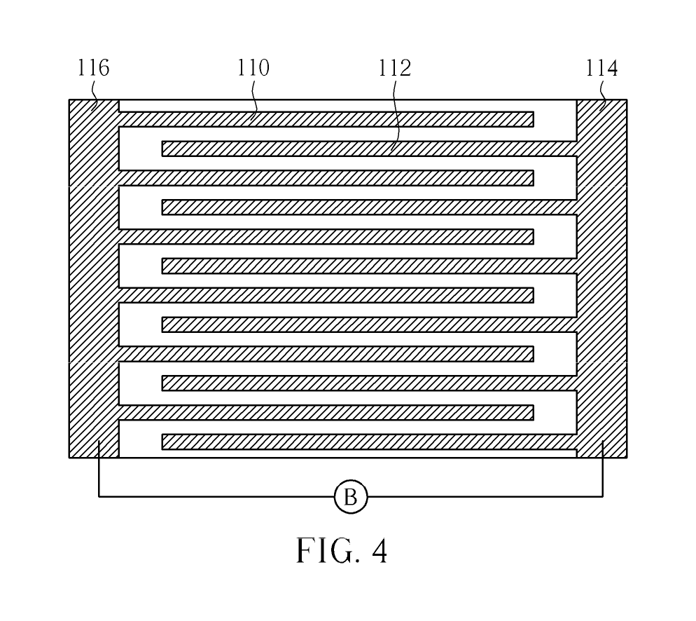

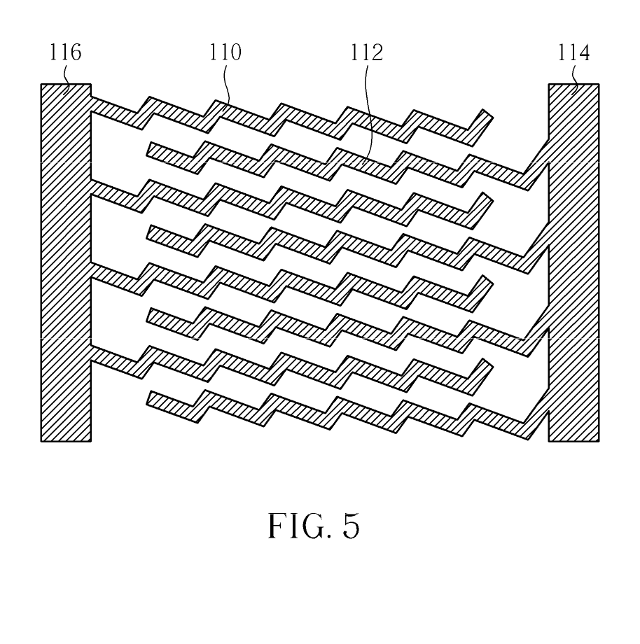

About the detail structure of the grating electrode, please refer to FIG. 4 and FIG. 5, illustrating top view schematic diagrams of the pattern of the grating electrode. As shown in FIG. 4, the grating electrode includes a plurality of first grating electrodes 110 and a plurality of second grating electrodes 112. Each first grating electrode no and each second grating electrode 112 are parallel and alternately arranged with each other. One end of each first grating electrode 110 is connected to a first grating main electrode 116 so that each first grating electrode 110 is electrically connected to each other. One end of each second grating electrode 112 is connected to a second grating main electrode 114 so that every second grating electrode 112 is electrically connected to each other. In another embodiment of the present invention, the first grating electrode 110 and the second grating electrode 112 are not stripe type electrodes. Instead, they can include a zigzag structure such as a Z-type or a thunder-type structure, as shown in FIG. 5. It is understood that the first grating electrode no and the second grating electrode 112 can be other structures. The principle is that the first grating electrode no and the second grating electrode 112 are arranged evenly on the substrate and insulated with each other.

The first substrate 102 and the second substrate 104 of the multi-stable LCD device 10, 20, 30 in the present invention include organic or inorganic transparent material, such as glass, quartz, plastic, resin or acrylic. The first electrode 104 and the second electrode 106 include a mono-layer structure or a multi-layer structure, wherein the material can include transparent conductive materials such as indium tin oxide (ITO), indium zinc oxide (IZO) or aluminum zinc oxide (AZO), but should not be limited thereto. It is noted that the liquid crystal molecules in the liquid crystal layer 108 of the multi-stable LCD device 10, 20, 30 include smectic liquid crystal molecules. In the preferred embodiment, the smectic liquid crystal molecules include achiral smectic type A liquid crystal molecules or achiral smectic type C liquid crystal molecules.

The dark state and the light state of the multi-stable LCD device 10, 20, 30 in the present invention can be switched by providing a planar electric field or a vertical electric field. The vertical electric field is provided by applying a voltage between the first electrode 104 and the second electrode 106, as the voltage A shown in FIG. 1, wherein the liquid crystal layer 108 is under a vertical electric field. The planar electric field is provided by altering the liquid crystal layer 108 under a planar electric field, as the voltage B shown in FIG. 1. In detail, the planer electric field is provided by applying a voltage B between the first main grating electrode 116 and the second main grating electrode 114, as shown in FIG. 4. The applied voltages A, B include A.C. or D.C. The frequency of A.C. is 1 HZ to 10,000 HZ and can be a triangle wave, a square wave or a sine wave, but should not be limited thereto.

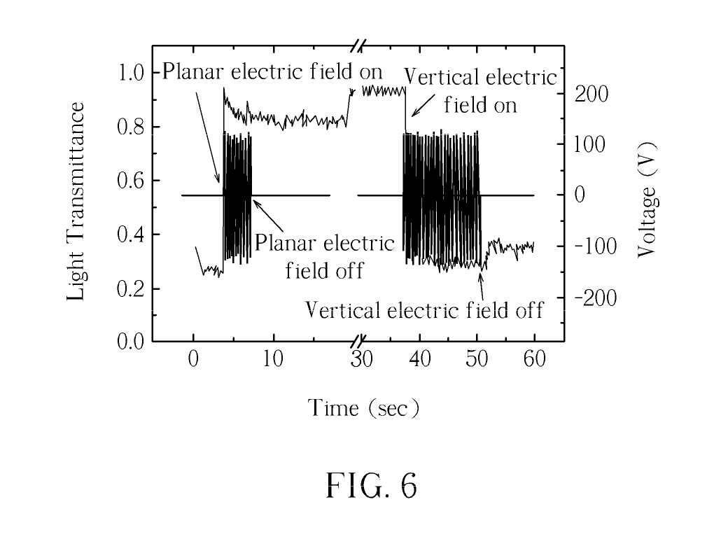

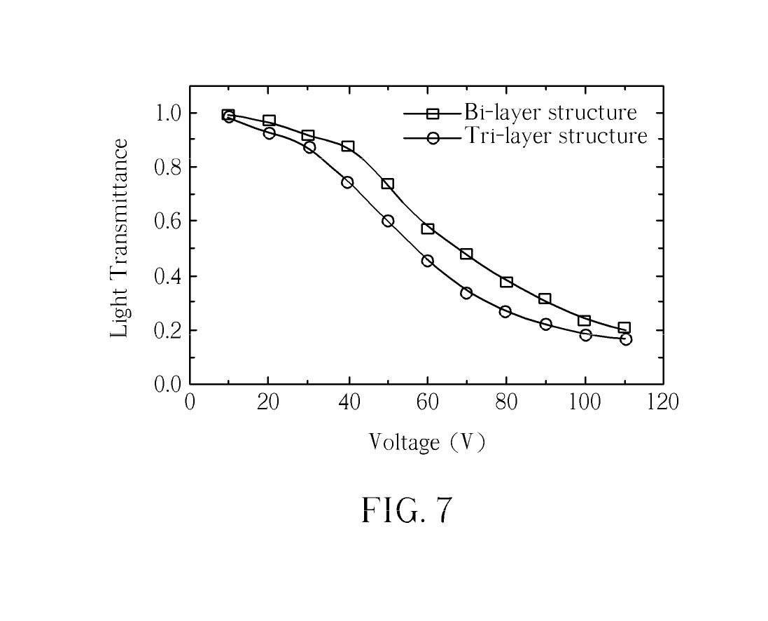

About the switch between the dark state and the light state, please refer to FIG. 6, illustrating a schematic diagram of the dark/light state switch of the multi-state LCD device in the present invention, wherein the x-axis represents time (sec) and the y-axis represents the light transmittance and the applied voltage (V). As shown in the left part of FIG. 6, when providing a planar electric field, the light transmittance of the liquid crystal molecules will increase, turning the image from the dark state to the light state. Even when removing the planar electric field, the light transmittance does not drop and the image stays in the light state. When providing a vertical electric field, the light transmittance starts to decrease and the image changes to the dark state. Even when removing the vertical electric field, the image still stays in the dark state. As shown in FIG. 6, the multi-state LCD device in the present invention at least has a bi-stable display function which can provide both the dark stable state and light stable state. Please refer to FIG. 7, illustrating a schematic diagram of the multi-stable display switch of the multi-stable LCD device in the present invention, wherein the x-axis represents the applied voltage (V) and the y-axis represents the light transmittance. Each spot on FIG. 7 shows the light transmittance of the liquid crystal molecules when removing the vertical electric field. Please refer to the square spots in FIG. 7 which represents the “bi-layer electrode structure” at first. As shown in FIG. 7, when providing different voltages, the liquid crystal molecules have different degrees of light transmittance correspondingly. Images with different light transmittance can therefore be obtained by controlling the voltages, thereby obtaining a gray level display mode. In comparison to conventional bi-stable display mode (dark/light), the multi-stable LCD device in the present invention can further include multi-stable display mode which can provide different gray level images, which is therefore applicable to a variety of fields. It is noted that these gray level images can be obtained by providing different degrees of voltages, or in another embodiment, can also be obtained by an A.C. current with the same degree of voltage but with different frequency.

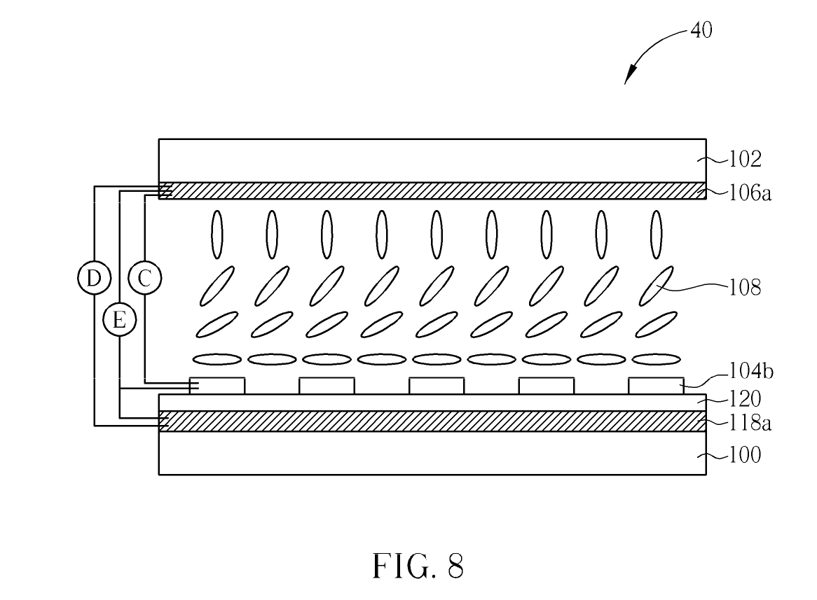

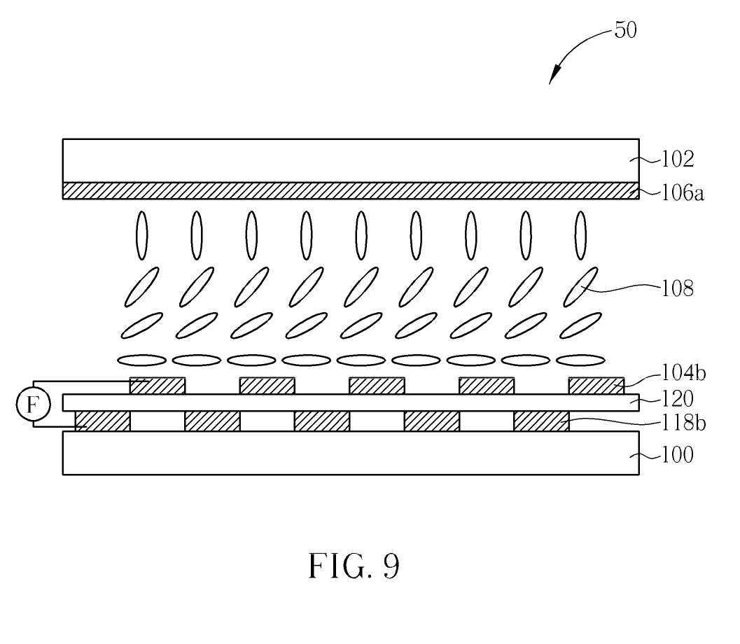

In order to enhance the contrast of the display device, besides the first embodiment of the “bi-layer electrode” structure, the present invention further provides a third embodiment of the “tri-layer electrode” structure. Please refer to FIG. 8 and FIG. 9, illustrating schematic diagrams of the second embodiment of the multi-stable LCD device in the present invention. As shown in FIG. 8, in addition to the first electrode 104 and the second electrode 106, the multi-stable LCD device 40 in the present embodiment further includes an auxiliary electrode 118a and an insulation layer 120, both of which are disposed between the first substrate 100 and the first electrode 104b. The insulation layer 120 is disposed on the auxiliary electrode 118a to insulate the first electrode 104b and the auxiliary electrode 118a. The material of the auxiliary electrode 118a can be the same as the first electrode 104b or the second first electrode 106a, such as a transparent conductive material, or can not be the same. The insulation layer 120 includes transparent dielectric material. The pattern of the auxiliary electrode 118a can be a planar electrode or a grating electrode, as shown in FIG. 9. It is noted that the grating structure of the auxiliary electrode 118b is arranged alternately with the above first electrode 104 in the vertical plane, so as to achieve a better effect of the electric field. It is understood that the grating structure of the auxiliary electrode 118b can be arranged in a stripe type structure as shown in FIG. 4, or can be arranged in a zigzag structure as shown in FIG. 5. Different embodiments of the auxiliary electrode 118 can be coupled with each implantation of the first embodiment. For example, the auxiliary electrode is a zigzag grating electrode, the first electrode 104 is a stripe type grating electrode, and the second electrode 106 is a planar electrode. The above-mentioned embodiments can be arranged arbitrarily, which are shown for the sake of simplicity.

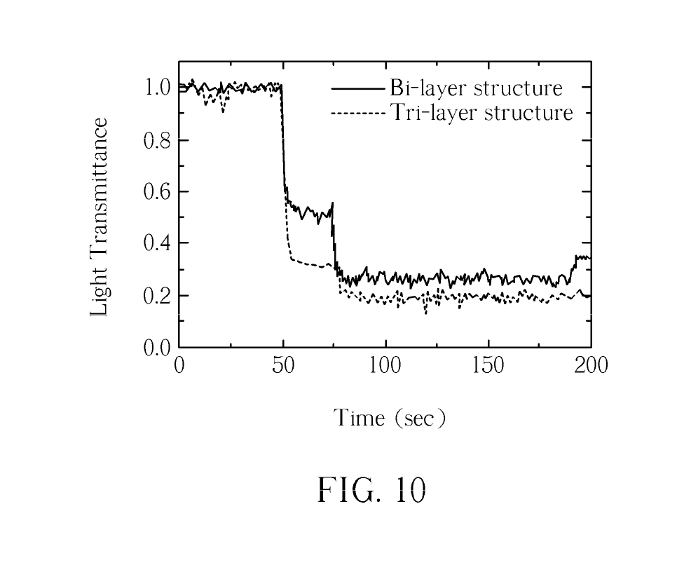

The “tri-layer electrode” structure of the present embodiment can effectively improve the display contrast. Please refer to FIG. 10, illustrating a schematic diagram of the contrast value of the second embodiment of the multi-stable LCD device in the present invention, wherein the solid line represents the “bi-layer electrode” in the first embodiment, and the dashed line represents the “tri-layer electrode” in the second embodiment. As shown in FIG. 10, the “bi-layer electrode” and the “tri-layer electrode” have the same light transmittance (1.0) at the beginning. After applying a vertical electric field, the “tri-layer electrode” has a lower light transmittance, meaning the difference of the light transmittance between the dark state and the light state becomes greater than the “bi-layer electrode”. The “tri-layer electrode” thereby has a better contrast. Besides, the “tri-layer electrode” in the present embodiment also has a multi-stable display mode. Please refer to FIG. 7 again. As shown in the circle dots which represent the “tri-layer electrode”, the liquid crystal molecules have different light transmittance after applying different degrees of voltage. The “tri-layer electrode” therefore can achieve the multi-stable display mode.

In the “tri-layer electrode” in the second embodiment, the dark state and the light state are also switched by applying a vertical electric field or a planar electric field. Please refer to FIG. 8, the vertical electric field can be provided by applying a voltage C between the first electrode 106b and the second electrode 104a, or, by applying a voltage D between the second electrode 106a and the auxiliary electrode 118a, or, by simultaneously applying a voltage E between the second electrode 104b, the first electrode 104b and the auxiliary electrode 118a, wherein the first electrode 104b and the auxiliary electrode 118a have isoelectrical potential, for example, the second electrode 106a has positive potential while the first electrode 104b and the auxiliary electrode 118a have negative potential. All of above driving methods can provide a vertical electric field onto the liquid crystal molecules in the liquid crystal layer 108. About the planar electric field, besides the embodiment of applying the voltage B between the first grating main electrode 116 and the second grating main electrode 114 as shown FIG. 4, the planar electric field can also be achieved by applying a voltage F between the first electrode 106b and the auxiliary electrode 118b, as shown in FIG. 9.

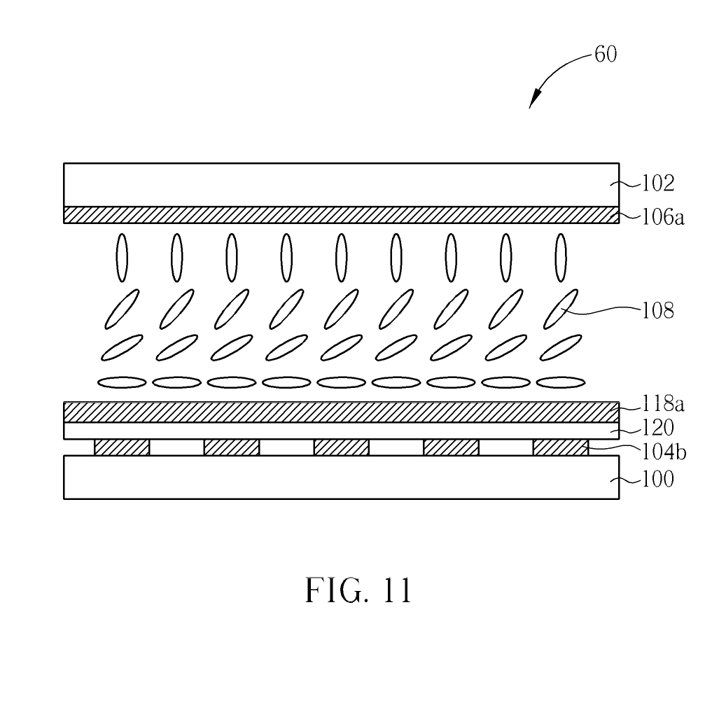

Please refer to FIG. 11, illustrating a schematic diagram of the third embodiment of the multi-stable LCD device in the present invention. In the third embodiment of the present invention, the auxiliary electrode 118a and the insulation layer 120 can also be disposed between the first electrode 108b and the liquid crystal layer 108. The insulation layer 120 is disposed below the auxiliary electrode 118a. Similarly, the auxiliary electrode 118 can include a grating electrode structure. The arrangement, material and driving method are similar with the above descriptions, which are not repeated.

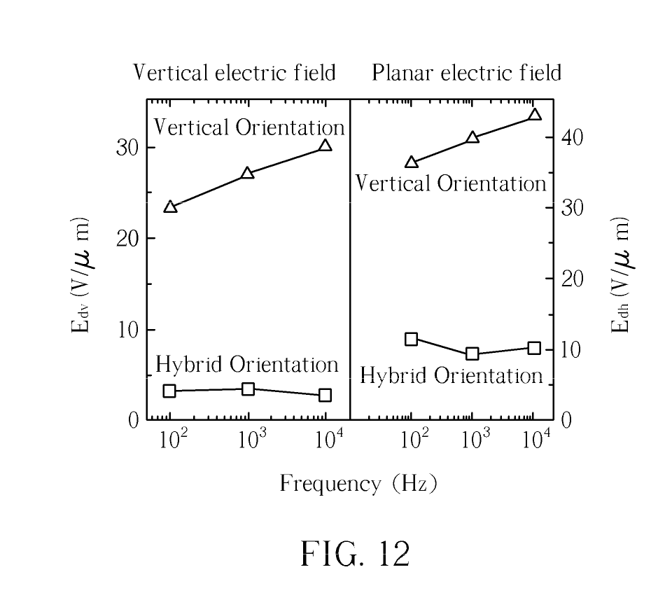

In addition to the novel electrode arrangement and driving method provided in the three embodiments, the orientation of the liquid crystal molecules in the liquid crystal layer 108 can include a horizontal orientation, a vertical orientation or a hybrid orientation. As shown in FIG. 1, the long axis of the liquid crystal molecules in the liquid crystal layer 108 is parallel to the first substrate 100, representing the horizontal orientation. As shown in FIG. 2, the long axis of the liquid crystal molecules in the liquid crystal layer 108 is perpendicular to the first substrate 100, representing the vertical orientation. As shown in FIG. 3, the orientation of the liquid crystal molecules that are close to the first substrate 100 in the liquid crystal layer 108 is the horizontal orientation. When closer to the second substrate 102, the orientation gradually changes to the vertical orientation, representing the hybrid orientation. In a preferred embodiment of the present invention, when utilizing the arrangement of the hybrid orientation, the driving voltage can be lowered. Please refer to FIG. 12, illustrating a schematic diagram of a comparison of the voltages between the hybrid orientation and the vertical orientation in the present invention, wherein the x-axis represents the frequency of the A.C. voltage and the y-axis represents the degrees of the driving electric field. Please refer to the left part of FIG. 12 firstly. Each static spots represents the electric field needed in switching the light state to the dark state of the liquid crystal molecules, that is, the driving value of the vertical electric field. It is clear that no matter the values of frequency the A.C. voltage, the needed driving electric field of the “hybrid orientation” which is shown in solid square dots is much greater than that of the “vertical orientation” which is shown in hollow triangle dots. Similarly, as shown in the right part of FIG. 12 which shows the needed driving value of the planar electric field, the driving electric field of the hybrid orientation is also smaller than that of the vertical orientation. Accordingly, whether in terms of the planar electric field or the vertical planer electric field, the driving voltage of the hybrid orientation is smaller than that of the vertical orientation and the planar alignment. At a result, the hybrid orientation in the present invention which is utilized in the multi-stable LCD device can lead to a lower driving voltage and is advantageous in power consumption.

According to the design of the backlight module, the multi-stable LCD device in the present invention can be applied in transmissive type LCD device, or be applied in reflective type LCD device. The transmissive type LCD is similar with conventional LCD devices that need only two polarizers disposed on the outer sides of the LCD devices. A light source is provided in one side of the LCD device and then the observer can catch an image on the other side. In the display mode of a reflective type LCD, the observer can catch an image from the same side of the LCD device by reflecting the outer light source. It is noted that when the multi-stable LCD device is a reflective type LCD, the electrode and the substrate on the opposite side relatively to the observer can made of non-transparent materials. For example, the electrode can be metal and the substrate can be silicon substrate.

In light of above, the present invention provides a multi-stable LCD device and the driving methods thereof, which is applicable to smectic liquid crystal molecules. When utilizing novel electrode arrangements, or using bi-layer or tri-layer structure, the multi-stable LCD device can not only have multi-stable gray levels display mode, but also have the advantages of high-contrast and low-power-consumption. The multi-stable LCD device can also be applied in transmissive type or reflective type LCD, greatly spreading out the application filed of the multi-stable LCD device.

Those skilled in the art will readily observe that numerous modifications and alterations of the device and method may be made while retaining the teachings of the invention.

What is claimed is:

1. A multi-stable liquid crystal display device, comprising:
a first substrate;
a second substrate disposed opposite to the first substrate;
a first electrode disposed on the first substrate;
a second electrode disposed on a side of the second substrate facing the first electrode, wherein at least one of the first electrode and the second electrode comprises a grating electrode; and
a liquid crystal layer disposed between the first electrode and the second electrode, wherein the liquid crystal layer comprises smectic liquid crystal molecules.

2. The multi-stable liquid crystal display device in claim 1, wherein the smectic liquid crystal molecules comprise achiral smectic type A liquid crystal molecules or achiral smectic type C liquid crystal molecules.

3. The multi-stable liquid crystal display device in claim 1, wherein the grating electrode comprises a plurality of first grating electrodes and a plurality of second grating electrodes, wherein each first grating electrode and each second grating electrode are parallel and alternately arranged with each other.

4. The multi-stable liquid crystal display device in claim 3, wherein the first grating electrodes and the second electrodes comprise a zigzag structure.

5. The multi-stable liquid crystal display device in claim 3, wherein the first grating electrodes and the second grating electrodes comprise a planar electric field.

6. The multi-stable liquid crystal display device in claim 1, wherein the first electrode and the second electrode comprises a vertical electric field.

7. The multi-stable liquid crystal display device in claim 1, further comprising an auxiliary electrode disposed between the first substrate and the first electrode, and an insulation layer disposed between the auxiliary electrode and the first electrode.

8. The multi-stable liquid crystal display device in claim 3, wherein the auxiliary electrode comprises an auxiliary grating electrode.

9. The multi-stable liquid crystal display device in claim 8, wherein the auxiliary grating electrode comprises a zigzag structure.

10. The multi-stable liquid crystal display device in claim 8, wherein the auxiliary grating electrode and the grating electrode are alternately arranged with each other.

11. The multi-stable liquid crystal display device in claim 7, wherein the auxiliary electrode and the second electrode comprise a vertical electric field.

12. The multi-stable liquid crystal display device in claim 7, wherein the first electrode, the second electrode and the auxiliary electrode comprise a vertical electric field, and the first electrode and the auxiliary electrode have isoelectrical potential.

13. The multi-stable liquid crystal display device in claim 7, wherein the auxiliary electrode and the first electrode comprise a planar electric field.

14. The multi-stable liquid crystal display device in claim 1, further comprising an auxiliary electrode disposed between the first electrode and the liquid crystal layer, and an insulation layer disposed between the auxiliary electrode and the first electrode.

15. The multi-stable liquid crystal display device in claim 14, wherein the auxiliary electrode and the second electrode comprise a vertical electric field.

16. The multi-stable liquid crystal display device in claim 14, wherein the first electrode, the second electrode and the auxiliary electrode comprise a vertical electric field, and the first electrode and the auxiliary electrode have isoelectrical potential.

17. The multi-stable liquid crystal display device in claim 14, wherein the auxiliary electrode and the first electrode comprise a planar electric field.

18. A method of driving a multi-stable liquid crystal display device, comprising:
providing a multi-stable liquid crystal display device, comprising:
a first substrate;
a second substrate disposed opposite to the first substrate;
a first electrode disposed on the first substrate;
a second electrode disposed on a side of the second substrate facing the first electrode, wherein at least one of the first electrode and the second electrode comprises a grating electrode; and
a liquid crystal layer disposed between the first electrode and the second electrode, wherein the liquid crystal layer comprises smectic liquid crystal molecules;
providing a planar electric field to increase the light transmittance of the liquid crystal layer; and
providing a vertical electric field to decrease the light transmittance of the liquid crystal layer.

19. The method of driving a multi-stable liquid crystal display device in claim 18, wherein the step of providing the vertical electric field comprises applying a voltage between the first electrode and the second electrode.

20. The method of driving a multi-stable liquid crystal display device in claim 18, wherein the grating electrode comprises a plurality of first grating electrodes and a plurality of second grating electrodes, wherein each first grating electrode and each second grating electrode are parallel and alternately arranged with each other, wherein the step of providing the planar electric field comprises applying a voltage between the first grating electrodes and the second grating electrodes.

21. The method of driving a multi-stable liquid crystal display device in claim 18, wherein the multi-stable liquid crystal display device further comprises an auxiliary electrode disposed between the first electrode and the first substrate, and an insulation layer disposed between the auxiliary electrode and the first electrode.

22. The method of driving a multi-stable liquid crystal display device in claim 21, wherein the step of providing the vertical electric field comprises applying a voltage between the first electrode and the auxiliary electrode.

23. The method of driving a multi-stable liquid crystal display device in claim 21, wherein the step of providing the vertical electric field comprises applying a voltage between the first electrode, the second electrode and the auxiliary electrode, wherein the first electrode and the auxiliary electrode have isoelectrical potential.

24. The method of driving a multi-stable liquid crystal display device in claim 21, wherein the step of providing the planar electric field comprises applying a voltage between the first electrode and the auxiliary electrode.

25. The method of driving a multi-stable liquid crystal display device in claim 18, wherein the multi-stable liquid crystal display device further comprises an auxiliary electrode disposed between the first electrode and the liquid crystal layer, and an insulation layer disposed between the auxiliary electrode and the first electrode.

26. The method of driving a multi-stable liquid crystal display device in claim 25, wherein the step of providing the vertical electric field comprises applying a voltage between the second electrode and the auxiliary electrode.

27. The method of driving a multi-stable liquid crystal display device in claim 25, wherein the step of providing the vertical electric field comprises applying a voltage between the first electrode, the second electrode and the auxiliary electrode, wherein the first electrode and the auxiliary electrode have isoelectrical potential.

28. The method of driving a multi-stable liquid crystal display device in claim 25, wherein the step of providing the planar electric field comprises applying a voltage between the first electrode and the auxiliary electrode.
